(19) United States
(12) Patent Application Publication
(10) Pub. No.: US 2021/0118148 A1
(43) Pub. Date: Apr. 22, 2021

(54) METHOD AND ELECTRONIC DEVICE FOR CHANGING FACES OF FACIAL IMAGE

(71) Applicant: BEIJING DAJIA INTERNET INFORMATION TECHNOLOGY CO., LTD., Beijing (CN)

(72) Inventors: Xiaoqiang LIU, Beijing (CN); Guoxin ZHANG, Beijing (CN); Liqian MA, Beijing (CN); Boning ZHANG, Beijing (CN); Xuwei HUANG, Beijing (CN); Bo JIN, Beijing (CN)

(21) Appl. No.: 17/073,840

(22) Filed: Oct. 19, 2020

(30) Foreign Application Priority Data
Oct. 17, 2019 (CN) 201910989199.8

(51) Int. Cl. G06T 7/155; G06T 7/11; G06T 7/174; G06T 7/55; G06K 9/00; G06K 9/62

(52) U.S. Cl. CPC G06T 7/155; G06T 7/11; G06T 7/174; G06T 7/55; G06T 2207/30201; G06K 9/00362; G06K 9/6215; G06T 2207/20036; G06T 2207/10028; G06K 9/00221

(57) ABSTRACT

A method for changing faces for a facial image can include: acquiring three-dimensional facial posture information and three-dimensional facial key points of a target image and a designated image by three-dimensional face reconstruction based on the target image and the designated image; morphing the designated image into an image with the same facial posture information as the target image, the image being used as a reference image; controlling the three-dimensional facial key points, and acquiring two images matched in the three-dimensional facial key points by face-morphing the target image and the reference image; and acquiring a face-changed image by updating a facial texture of the face-morphed target image based on a facial texture of the face-morphed reference image.

This application claims priority to Chinese patent application No. 201910989199.8, filed on Oct. 17, 2019, in the China National Intellectual Property Administration, the disclosure of which is herein incorporated by reference in its entirety.

### TECHNICAL FIELD

The present disclosure relates to a method and electronic device for changing faces for a facial image.

### BACKGROUND

In the technical field of image processing, face changing for a facial image is a common image processing method. When a facial posture of the designated image is inconsistent with that of the target image, for example, when one is a front face and the other is a side face, it is difficult to acquire the designated image and the target image which are matched in facial contours and facial feature positions by morphing. As a result, it is impossible to realize effective face changing of the target image. It can be seen that the method for changing faces for the facial image in the related arts is has poor robustness.

### SUMMARY

The present disclosure provides a method for changing faces for a facial image, and an electronic device and a storage medium thereof. The technical solutions of the present disclosure are as follows.

According to an aspect of embodiments of the present disclosure, a method for changing faces for a facial image is provided. The method includes:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

According to another aspect of the embodiment of the present disclosure, an electronic device is provided. The electronic device includes:

a processor; and

a memory configured to store at least one instruction executable by the processor;

wherein the at least one instruction, when executed by the processor, enables the processor to perform a method including:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

According to another aspect of embodiments of the present disclosure, a storage medium storing at least one instruction therein is provided. The at least one instruction, when executed by a processor of an electronic device, enables the electronic device to perform a method including:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

According to another aspect of embodiments of the present disclosure, a computer program product is provided. The computer program product, when running on a processor of an electronic device, enables the electronic device to perform a method including:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

### BRIEF DESCRIPTION OF THE DRAWINGS

The accompanying drawings, which are incorporated in and constitute a part of this description, illustrate embodiments consistent with the present disclosure and, together with the description, serve to explain the principles of the present disclosure, and do not constitute an improper limitation of the present disclosure.

FIG. 1 is a flowchart of a method for changing faces for a facial image according to an embodiment of the present disclosure;

FIG. 2 is a schematic diagram showing face changing in a target image based on a designated image according to an embodiment of the present disclosure;

FIG. 3 is a schematic diagram of a histogram according to an embodiment of the present disclosure;

FIG. 4 is a block diagram of an apparatus for changing faces for a facial image according to an embodiment of the present disclosure;

FIG. 5 is a block diagram of an electronic device according to an embodiment of the present disclosure;

FIG. 6 is a block diagram of an apparatus for changing faces for a target image according to an embodiment of the present disclosure; and

FIG. 7 is a block diagram of another apparatus for changing faces for a target image according to an embodiment of the present disclosure.

### DETAILED DESCRIPTION

In order to enable those skilled in the art better understand technical solutions of the present disclosure, the technical solutions of the embodiments of the present disclosure will be described clearly and completely below in combination with the accompanying drawings.

It is to be noted that terms “first,” “second,” and the like in the description and claims, as well as the above accompanying drawings, of the present disclosure are used for the purpose of distinguishing similar objects instead of indicating a particular order or sequence. It should be understood that the data used in this way can be interchanged under appropriate circumstances, such that the embodiments of the present disclosure described herein can be implemented in an order other than the order illustrated or described herein. The implementations set forth in the following description of example embodiments do not represent all implementations consistent with the present disclosure. Instead, they are merely examples of apparatuses and methods consistent with aspects related to the present disclosure as recited in the appended claims.

In order to improve robustness of a method for changing faces for a facial image to achieve face changing of a target image when a facial posture in a designated image is inconsistent with that in the target image, the embodiments of the present disclosure provide a method and apparatus for changing faces for a facial image, and an electronic device and a storage medium thereof.

In some embodiments, an executive subject of the method for changing faces according to the present disclosure is an apparatus for changing faces for a facial image arranged in an electronic device. The electronic device is a server corresponding to a client or a terminal device installed with the client. For example, the terminal device is one of a smart phone, a computer, a digital broadcasting terminal, a messaging device, a game device, a tablet device, an entertainment device, a medical device, a fitness device and a personal digital assistant, or other devices with data receiving, data sending and data processing functions, which is not limited in the embodiments of the present disclosure.

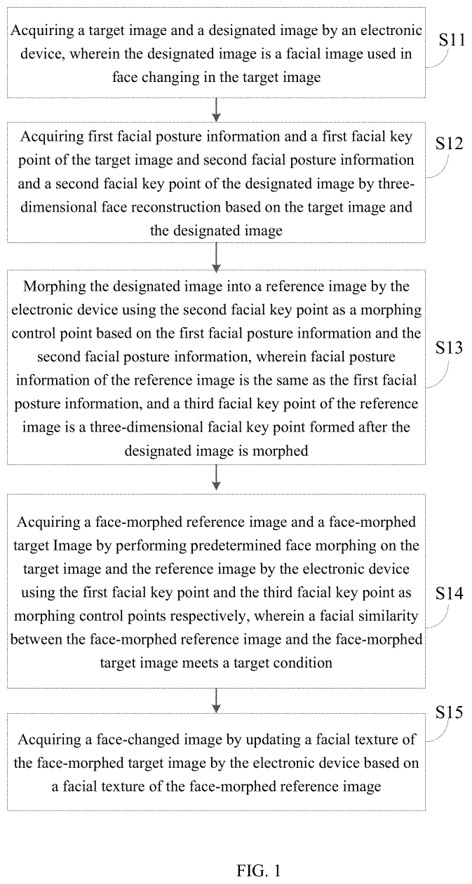

FIG. 1 is a flowchart of a method for changing faces for a facial image according to an embodiment of the present disclosure. In S11, an electronic device acquires a target image and a designated image, wherein the designated image is a facial image used in the face changing in the target image.

In some embodiments, the target image and the designated image are facial images. The term “facial” mentioned herein excludes hair and head decoration. Optionally, the target image and the designated image are facial images acquired by shooting faces of real persons or animals, or facial images of cartoon characters, or facial images generated by the electronic device, or the like, which are not limited in the embodiments of the present disclosure.

It can be understood that after the face changing in the target image based on the designated image, the face in the face-changed image is very similar to that in the designated image. For example, if eyes in the designated image are very small, even though eyes in the target image are very large, eyes in the acquired image may be small after the face changing of the target image based on the designated image.

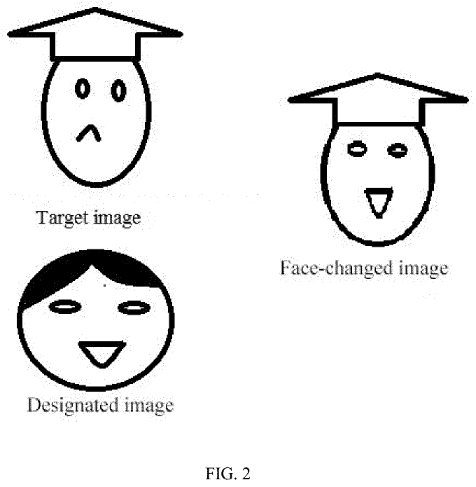

FIG. 2 shows a schematic diagram of face changing in a target image based on a designated image. It can be seen that the target image is a facial image with a hat, round eyes, a smaller face area, and a pursed mouth, while the designated image is a facial image without a hat but having oval eyes, a larger face area, and an open mouth. After using the designated image to realize the face changing of the target image, the original hat in the target image is kept, and the eyes and the mouth in the target image become the eyes and the mouth in the designated image. That is, the face of the target image becomes the face of the designated image, but a hairstyle in the designated image does not change into the target image accordingly. It should be noted that this schematic diagram is only used to explain the basic principle of the face changing of the target image, and a display effect after the face changing shown in the figure does not constitute the limitation of the present disclosure.

In S12, the electronic device acquires first facial posture information and a first facial key point of a target image and second facial posture information and a second facial key point of a designated image by three-dimensional face reconstruction based on the target image and the designated image.

In some embodiments, the first facial posture information and the second facial posture information are three-dimensional facial posture information, and the first facial key point and the second facial key point are three-dimensional facial key points. It can be understood that compared with two-dimensional facial key point, the three-dimensional facial key point defines coordinates of the facial image in the depth direction; while coordinates of the two-dimensional facial key point are the two-dimensional coordinates of the facial key point in the facial image. For example, for the same key point on the same facial image, if the key point is the two-dimensional key point, the coordinates of the key point are (a, b), and a and b can represent the position of the key point on the facial image. If the key point is the three-dimensional key point, the coordinates of the key point are (a, b, c), wherein a and b can represent the position of the key point on the facial image, and c represents a distance between the key point and a screen.

The facial posture which can be characterized by the facial posture information acquired in this step is a posture of the face in the facial image in the three-dimensional direction. The facial posture information is one or more kinds of data configured to characterize the facial posture of the facial image. For example, the facial posture information includes a deflection angle of the facial image relative to a front face image, a scaling ratio of the facial image relative to a preset standard face, displacement data of the facial image relative to the preset standard face, and the like. Optionally, the deflection angle of the facial image relative to the front face image includes rotation angles of the facial image relative to the front face image in an X-axis direction and a Y-axis direction of the face. Of course, the data that can characterize the facial posture of the facial image are not limited to the three kinds of data shown herein, and any data that can characterize the facial posture of the facial image may be used as the facial posture information applied to the present disclosure.

In some embodiments, the step of acquiring first facial posture information and a first facial key point of a target image and second facial posture information and a second facial key point of a designated image by three-dimensional face reconstruction based on the target image and the designated image may be performed in a variety of ways, one of which is described as an example below.

In some embodiments, the electronic device determines the two-dimensional facial key point of the target image and the two-dimensional facial key point of the designated image. The electronic device inputs the two-dimensional facial key point of the target image and the two-dimensional facial key point of the designated image into a preset three-dimensional facial reconstruction model through which the two-dimensional facial key points are converted into three-dimensional facial key points to acquire the first facial posture information and the first facial key point of the target image and the second facial posture information and the second facial key point of the designated image.

In some embodiments, the three-dimensional facial reconstruction model is a model with prior information required for three-dimensional facial reconstruction, and has the ability of converting the two-dimensional facial key point of the facial image into the three-dimensional facial key point of the facial image. Therefore, after the two-dimensional facial key point of the facial image is input into the three-dimensional facial reconstruction model, the three-dimensional facial reconstruction model can output the facial posture information of the facial image and the reconstructed three-dimensional facial key point. Optionally, many types of three-dimensional facial reconstruction models are available for three-dimensional facial reconstruction, such as Basel Face Model 2009 (BFM) or other models with the three-dimensional facial reconstruction ability, which is not limited in the embodiments of the present disclosure.

In some embodiments, the used two-dimensional facial key point of the target image and the two-dimensional facial key point of the designated image are feature points extracted from the two facial images respectively. Optionally, the electronic device can extract the two-dimensional facial key point from the facial image based on a feature point extraction algorithm or a feature point extraction model. Optionally, the feature point extraction algorithm may be Susan operator, or a feature point extraction algorithm in OPENCV, or the like, which is not limited thereto. The feature point extraction model may be Dlib's face recognition module, which is not limited thereto. The Susan operator is a feature point acquisition method based on a gray level. The Dlib library is a cross-platform C++ library. The OPENCV is a cross-platform computer vision library.

In S13, the electronic device morphs the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed.

In some embodiments, in order to morph the designated image into an image with the same facial posture information as the first facial posture information, the electronic device needs to determine what the facial posture information of the designated image is before and after the morphing. The facial posture information of the designated image is the second facial posture information before the morphing, and the facial posture information of the designated image is the same as the first facial posture information after the morphing. Therefore, the electronic device can morph the designated image into the reference image by using the second facial key point as the morphing control point based on the first facial posture information and the second facial posture information, and the facial posture information of the reference image is the same as the first facial posture information. In addition, as the position of the three-dimensional facial key point of the designated image is changed after the morphing, the third facial key point of the reference image is the three-dimensional facial key point formed after the designated image is morphed.

The electronic device can morph the designated image into the reference image with the same facial posture information as the first facial posture information, so as to adjust the facial posture of the designated image. In the case that the designated image is subjected to the image morphing, the second facial key point of the designated image is used as the control point to morph the designated image. Optionally, the electronic device moves the second facial key point as the morphing control point in the designated image, such that the facial posture information of the reference image acquired after the movement is the same as the first facial posture information. That is, the facial posture of the designated image can be adjusted.

In some embodiments, the electronic device determines first morphing coordinates based on the first facial posture information and the second facial posture information, wherein the first morphing coordinates are coordinates to which the second facial key point is to be moved in the case that the designated image is morphed into the reference image. The electronic device acquires the reference image by moving the second facial key point to a position indicated by the first morphing coordinates.

In some embodiments, morphing the designated image into the reference image by the electronic device may be performed by adopting a first image morphing method which includes a triangle morphing method, a move least square method, a least square programming algorithm, a grid-based free form morphing method, etc. The embodiments of the present disclosure do not limit the type of the first image morphing method.

The distribution of coordinates of the first facial key point corresponds to the first facial posture information, and the distribution of coordinates of the second facial key point corresponds to the second facial posture information. Therefore, a process that the electronic device determines the first morphing coordinates required in the case that the designated image is morphed into the reference image based on the first facial posture information and the second facial posture information is a process that the electronic device determines a coordinate difference between coordinates of the second facial key point and coordinates of the first facial key point on the basis of a difference between the first facial posture information and the second facial posture information. The electronic device acquires the first morphing coordinates by transforming the coordinates of the second facial key point based on the coordinate difference, wherein the distribution of the first morphing coordinates corresponds to the first facial posture information. In this way, by using the first image morphing method, the electronic device moves the second facial key point of the designated image to the position indicated by the first morphing coordinates, and thus, the reference image with the same facial posture information as the first facial posture information can be acquired.

In some embodiments, the facial posture information includes the deflection angle, scaling ratio and displacement data listed above. In addition, in the facial posture information of the designated image, the deflection angle is (90°, 0°), the scaling ratio is 1:1, and the displacement data represents left offset of one unit distance in the horizontal direction, and is expressed as (−1, 0). In the facial posture information of the target image, the deflection angle is (0°, 0°), the scaling ratio is 1:1, and the displacement data is (0, 0). That is, the target image has no deflection, no scaling, or no displacement relative to the standard face. As for the facial posture information of the designated image, the difference between the facial posture information of the designated image and the target image lies in that the designated image is deflected by 90 degrees in the X-axis direction relative to the target image, and the designated image is left offset by one unit distance in the horizontal direction relative to the target image. Based on this difference, the electronic device reversely deflects the coordinates of the second facial key point by 90 degrees in the X-axis direction of the face, and acquires the first morphing coordinates by right offset of one unit distance in the horizontal direction. It should be noted that the unit distance in this example may also be customized by the user, which is not limited in the embodiments of the present disclosure.

In S14, the electronic device acquires a face face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition.

The electronic device performs face morphing on the target image and the reference image by using the first facial key point and the third facial key point as morphing control points respectively, and performs image morphing on the target image and the reference image toward a set of same morphing coordinates, and thus acquires the two images matched in the three-dimensional facial key points. The matching in the three-dimensional facial key points means that the facial similarity between the two images meets the target condition. Furthermore, this set of morphing coordinates is determined based on the coordinates of the first facial key point and the coordinates of the second facial key point. For the sake of clear solution and layout. In some embodiments, the matching in the three-dimensional facial key points or the facial similarity between the two images meeting the target condition means that the geometric proportions of facial contours and facial features of the two images are the same. When the similarity of the two images is calculated by a facial similarity algorithm, the calculated similarity is greater than a predetermined threshold. From the visual effect point of view, the facial contours and the facial feature positions of both the face-morphed reference image and the face-morphed target image tend to be consistent.

An example description is given to the specific practice of acquiring the two images matched in the three-dimensional key points below by face-morphing the target image and the reference image by using the first facial key point and the third facial key point as the morphing control points respectively.

In some embodiments, the electronic device determines second morphing coordinates which are weighted average coordinates of coordinates of the third facial key point and coordinates of the first facial key point. The electronic device acquires the face-morphed reference image and the face-morphed target image by moving the third facial key point and the first facial key point respectively to the positions indicated by the second morphing coordinates in the images corresponding to the third facial key point and the first facial key point respectively.

In some embodiments, the electronic device takes the weighted average coordinates of the coordinates of the third facial key point and the coordinates of the first facial key point as the second morphing coordinates based on a preset weight ratio. The electronic device acquires the face-morphed reference image and the face-morphed target image by moving, by using a second image morphing method, the third facial key point and the first facial key point respectively to the positions indicated by the second morphing coordinates in the images corresponding to the third facial key point and the first facial key point respectively.

In some embodiments, the preset weight ratio is set according to an actual situation. For example, weights corresponding to the coordinates of the third facial key point and the coordinates of the first facial key point are set to be the same. That is, the preset weight ratio is 1:1. Of course, the weights corresponding to the coordinates of the third facial key point and the coordinates of the first facial key point may be set to be different, such as 1:1.5 or 1:2, which is not limited in the embodiments of the present disclosure.

In some embodiments, the process that the electronic device determines the average coordinates of the two coordinates is a process that the electronic device calculates coordinates of a midpoint position of a connection line of the two coordinates. When the electronic device determines the weighted average coordinates, a position indicated by the calculated weighted average coordinates approaches the coordinates corresponding to the larger weight accordingly.

In some embodiments, the second morphing coordinates are coordinates of a facial key point of a fusion image of the target image and the reference image. When the preset weight ratio is 1:1, the fusion image is an image of an average face of the target image and the reference image.

In some embodiments, the second image morphing method is a move least squares (MLS) method, or the like, but is not limited thereto. The morphed image can be smoother without edges and corners by using the move least square method.

In some embodiments, before determining the second morphing coordinates, the electronic device may determine target morphing coordinates that are the coordinates to which a mouth key point in the first facial key point is to be moved; and the target morphing coordinates are configured to adjust a mouth open ratio of the target image to be the same as that of the reference image. The mouth open ratio can be defined by dividing an opening distance of the mouth by a width of the mouth. The electronic device moves the mouth key point to the position indicated by the target morphing coordinates, and updates the first facial key point to the facial key point corresponding to the target image after the mouth key point is moved.

In this way, in the subsequent step of determining the second morphing coordinates, the used first facial key point is the three-dimensional facial key point of the target image formed after the mouth key point is moved. Meanwhile, in the subsequent step of acquiring a face-morphed reference image and a face-morphed target image by respectively moving the third facial key point and the first facial key point to the positions indicated by the second morphing coordinates, the used first face key point is also the three-dimensional face key point of the target image formed after the mouth key point is moved. Thus, it may be ensured that that the mouth in the image after the movement of the key point is closer to the actual situation, and the image display effect is more realistic.

In the above image processing process, the mouth open ratio of the target image may be the same as or different from that of the reference image. When the mouth open ratios of the two facial images are different, the electronic device can first adjust the mouth open ratio of the target image to be the same as that of the reference image, and then determine the second morphing coordinates. In this way, the mouth open ratio of the finally acquired image subjected to the face changing is more fit for the mouth open ratio of the reference image, namely, is more fit for the mouth open ratio of the original designated image. In contrast, if the second morphing coordinates are directly determined and the face morphing is performed on the two facial images respectively based on the second morphing coordinates, the mouth open ratios of the acquired two images may affect the final face changing effect. For example, assuming that the mouth in the reference image is open and the mouth in the target image is closed, the mouth open ratios of the two images acquired after the two facial images are face-morphed based on the second morphing coordinates are not fit for either of the two facial images, which affects the face changing effect.

In some embodiments, the mouth open ratios of the reference image and the target image can be determined by the electronic device based on the coordinates of the first facial key point and the coordinates of the third facial key point respectively. For example, the electronic device determines the width of the mouth based on the coordinates of the key points located at the corners of both sides in the first and third facial key points, and determines the opening distance of the mouth based on coordinates of a key point located at the upper edge of the mouth and coordinates of a key point located at the lower edge of the mouth; and the mouth open ratio can be acquired by dividing the opening distance of the mouth by the width of the mouth.

In some embodiments, when moving the mouth key point, the electronic device can use a third image morphing method, wherein the third image morphing method is a triangle morphing method. Using the triangle morphing method, the mouth key point of the target image can be completely morphed to the position indicated by the target morphing coordinates, such that the mouth open ratio of the target image subjected to the mouth-morphing is completely fit to the mouth open ratio of the reference image, thereby reducing deviation.

In some embodiments, the electronic device first enables, by using the triangle morphing method, the mouth open ratio of the target image to be completely fit to the mouth open ratio of the reference image, and then morphs the target image and the reference image by using the move least square method, such that the relatively smooth face-morphed reference image and face-morphed target image are acquired.

In S15, the electronic device acquires a face-changed image by updating a facial texture of the face-morphed target image based on a facial texture of the face-morphed reference image.

The face-changed image is the face-morphed target image. The facials form, facial feature positions and facial feature size in the face-morphed reference image are very similar to those in the face-morphed target image, but the facial texture of the face-morphed target image is still the original facial texture. As different facial textures can show different skin colors, different skin textures and other characters, updating the facial texture of the face-morphed target image based on the facial texture of the face-morphed reference image enable the skin color, skin texture and other characters of the face-changed image to be more similar to those of the designated image, thereby achieving a better face changing effect.

In some embodiments, the electronic device determines mouth states of the target image and the reference image, and determines an update mode of the facial texture of the face-morphed target image based on the mouth states of the target image and the reference image.

The electronic device updates a setting parameter of a histogram of a skin region in the face-morphed target image according to a histogram of a skin region in the face-morphed reference image in response to a situation that the mouth state of the face-morphed reference image is the same as the mouth state of the face-morphed target image.

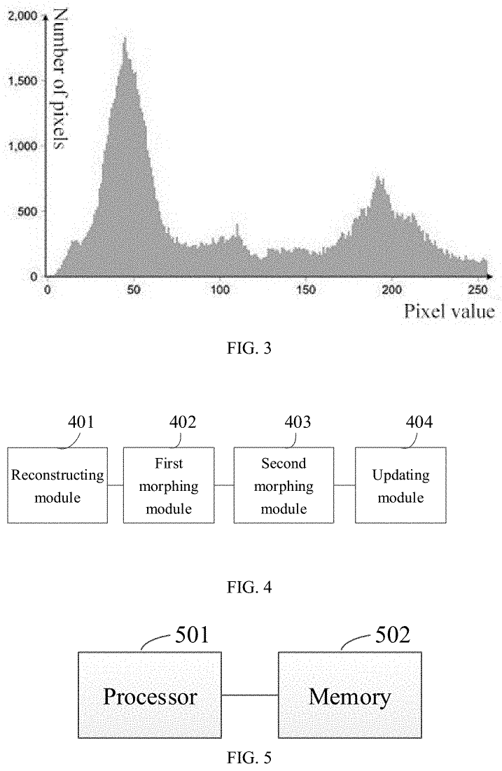

FIG. 3 shows the histogram forms of the two facial images, wherein the horizontal axis represents respective pixel values of the facial image, and the vertical axis represents the number of pixels under each pixel value. It can be understood that after updating the setting parameter of the histogram of the skin region in the face-morphed target image, the distribution of the pixel values and the number of pixels in the histogram of the acquired face-changed image is similar to that in the histogram of the face-morphed reference image. In this way, the skin of the face-changed image can be the same as or similar to the skin of the face-morphed reference image, namely, the same as or similar to the skin of the designated image, thereby achieving a better face changing effect.

The electronic device can adjust the mouth open ratio of the target image to be the same as that of the reference image in response to a situation that the mouth state of the face-morphed reference image is different from the mouth state of the face-morphed target image.

In some embodiments, the electronic device determines the update mode of the facial texture of the face-morphed target image based on the mouth state of the face-morphed reference image, and acquires the face-changed image by updating the facial texture of the face-morphed target image based on the facial texture of the face-morphed reference image and the update mode.

In some embodiments, the electronic device can adopt different processing ways based on the mouth state of the face-morphed reference image.

The electronic device can update a setting parameter of a histogram of a skin region in the face-morphed target image according to a histogram of a skin region in the face-morphed reference image in response to the mouth state being a closed state.

In some embodiments, when the mouth in the designated image is in a closed state, if the mouth in the target image before the mouth open ratio is adjusted is an open state, the mouth in the target image is in the closed state after the face morphing of the target image. At this time, it may be only necessary to update the setting parameter of the histogram of the skin region in the face-morphed target image according to the histogram of the skin region in the face-morphed reference image. If the mouth in the target image before the mouth open ratio is adjusted is also in the closed state, likewise, it may be only necessary to update the setting parameter of the histogram of the skin region in the face-morphed target image.

The electronic device can fill a texture of an oral portion in the face-morphed reference image into an oral portion in the face-morphed target image in response to the mouth state being an open state, and updates a setting parameter of a histogram of a skin region in the face-morphed target image according to a histogram of a skin region in the face-morphed reference image.

In some embodiments, in the case that the mouth in the designated image is in an open state, if the mouth in the target image before the mouth open ratio is adjusted is also in the open state, the electronic device fills the texture of the oral portion in the face-morphed reference image into the oral portion in the face-morphed target image, such that the texture of the oral portion in the face-changed image is consistent with that of the oral portion in the designated image. For example, if the teeth in the designated image are neat but the teeth in the target image before the mouth open ratio is adjusted are buckteeth, the teeth in the acquired face-changed image are consistent with those in the designated image after the electronic device performs the step of filling the texture into the oral portion. That is, the buckteeth in the target image are morphed into the neat teeth in the designated image, such that the face changing effect is better. If the step of filling the texture into the oral portion is not performed, the buckteeth may still remain in the face-changed image, which will affect the face changing effect.

In addition, when the mouth in the designated image is in an open state, if the mouth in the target image is in a closed state before the mouth open ratio is adjusted, the mouth in the target image is adjusted to be in the open state after the electronic device adjusts the mouth open ratio of the target image. However, as the texture of the oral portion in the face-morphed target image is derived from a morphed lip texture, it may be inconsistent with a texture of a real oral portion, affecting the face changing effect. Therefore, the electronic device can avoid or minimize the inconsistency discussed above by filling the texture of the oral portion in the face-morphed reference image into the oral portion in the face-morphed target image, so as to achieve a better face changing effect.

FIG. 4 is a block diagram of an apparatus for changing faces for a facial image according to an embodiment of the present disclosure. Referring to FIG. 4, the apparatus includes: a reconstructing module 401, a first morphing module 402, a second morphing module 403, and an updating module 404.

The reconstructing module 401 is configured to acquire first facial posture information and a first facial key point of a target image and second facial posture information and a second facial key point of a designated image by three-dimensional face reconstruction based on the target image and the designated image, wherein the designated image is a facial image used in the face changing of the target image.

In some embodiments, the first facial posture information and the second facial posture information are three-dimensional facial posture information, and the first facial key point and the second facial key point are three-dimensional facial key points.

The first morphing module 402 is configured to morph the designated image into a reference image by using the second facial key point as a morphing control point based on the first facial posture information and the second facial posture information, wherein facial posture information of the reference image are the same as the first facial posture information, and a third facial key point of the reference image is a three-dimensional facial key point formed after the designated image is morphed.

The second morphing module 403 is configured to acquire a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition.

The updating module 404 is configured to acquire a face-changed image by updating a facial texture of the face-morphed target image based on a facial texture of the face-morphed reference image.

In some embodiments, the first morphing module 402 is configured to:

determine first morphing coordinates based on the first facial posture information and the second facial posture information, wherein the first morphing coordinates are coordinates to which the second facial key point is to be moved in the case that the designated image is morphed into the reference image; and

acquire the reference image by moving the second facial key point to a position indicated by the first morphing coordinates.

In some embodiments, the second morphing module 403 is configured to:

determine second morphing coordinates which are weighted average coordinates of coordinates of the third facial key point and coordinates of the first facial key point; and

acquire the face-morphed reference image and the face-morphed target image by moving the third facial key point and the first facial key point to positions indicated by the second morphing coordinates in images corresponding to the third facial key point and the first facial key point respectively.

In some embodiments, the apparatus further includes a determining module and a third morphing module.

The determining module is configured to determine target morphing coordinates, wherein the target morphing coordinates are coordinates to which a mouth key point in the first facial key point is to be moved, and are configured to adjust a mouth open ratio of the target image to be the same as that of the reference image.

The third morphing module is configured to move the mouth key point to a position indicated by the target morphing coordinates.

In some embodiments, the updating module 404 is configured to:

determine an update mode of the facial texture of the face-morphed target image based on a mouth state of the face-morphed reference image in response to a situation that the mouth state of the face-morphed reference image is different from a mouth state of the face-morphed image with face to be change; and

acquire the face-changed image by updating the facial texture of the face-morphed target image based on the facial texture of the face-morphed reference image and the update mode.

In some embodiments, the updating module 404 is configured to:

fill a texture of an oral portion of the face-morphed reference image into an oral portion of the face-morphed target image in response to the mouth state being an open state, and update a setting parameter of a histogram of a skin region in the face-morphed target image according to a histogram of a skin region in the face-morphed reference image.

In some embodiments, the updating module 404 is configured to:

update a setting parameter of a histogram of a skin region in the face-morphed target image according to a histogram of a skin region in the face-morphed reference image in response to the mouth state being a closed state.

In some embodiments, the updating module 404 is configured to:

update a setting parameter of a histogram of a skin region in the face-morphed target image according to a histogram of a skin region in the face-morphed reference image in response to a situation that the mouth state of the face-morphed reference image is the same as the mouth state of the face-morphed target image.

In the apparatus for changing faces for the facial image according to the embodiment of the present disclosure, the three-dimensional facial reconstruction is performed on the target image and the designated image, and the target image is adjusted on the basis of a three-dimensional facial reconstruction result, such that the face in the target image is similar to that in the designated image, thereby acquiring the face-changed image with the better face changing effect. The three-dimensional facial reconstruction is adopted in the face changing process, and the dimensions added by the three-dimensional facial reconstruction can distinguish different portions of a human face. Compared with two-dimensional facial reconstruction, even if facial postures in the designated image and the target image are inconsistent, the face changing of the target image can still be realized. It can be seen that the apparatus for changing faces for the facial image according to the embodiment of the present disclosure has stronger robustness.

With respect to the apparatus in the above embodiment, the specific operations performed by the individual modules in the apparatus have been described in detail in the embodiments of the related methods, which are not elaborated herein.

FIG. 5 is a block diagram of an electronic device according to an embodiment of the present disclosure. As shown in FIG. 5, the electronic device includes:

a processor 501; and

a memory 502 configured to store at least one instruction executable by the processor 501,

wherein the at least one instruction, when executed by the processor 501, enables the processor 501 to perform following steps:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

In some embodiments, the at least one instruction, when executed by the processor 501, enables the processor 501 to perform the following steps:

determining first morphing coordinates based on the first facial posture information and the second facial posture information, wherein the first morphing coordinates are coordinates to which the second facial key point is to be moved in the case that the designated image is morphed into the reference image; and

acquiring the reference image by moving the second facial key point to a position indicated by the first morphing coordinates.

In some embodiments, the at least one instruction, when executed by the processor 501, enables the processor 501 to perform the following steps:

determining second morphing coordinates which are weighted average coordinates of coordinates of the third facial key point and coordinates of the first facial key point; and

acquiring the face-morphed reference image and the face-morphed target image by moving the third facial key point and the first facial key point to positions indicated by the second morphing coordinates in images corresponding to the third facial key point and the first facial key point respectively.

In some embodiments, the at least one instruction, when executed by the processor 501, enables the processor 501 to perform the following steps:

determining target morphing coordinates, wherein the target morphing coordinates are coordinates to which a mouth key point in the first facial key point is to be moved, and are configured to adjust a mouth open ratio of the target image to be the same as that of the reference image; and

moving the mouth key point to a position indicated by the target morphing coordinates.

In some embodiments, the at least one instruction, when executed by the processor 501, enables the processor 501 to perform the following steps:

determining an update mode of the facial texture of the face-morphed target image based on a mouth state of the face-morphed reference image in response to a situation that the mouth state of the face-morphed reference image is different from a mouth state of the face-morphed target image; and

acquiring the face-changed image by updating the facial texture of the face-morphed target image based on the facial texture of the face-morphed reference image and the update mode.

In some embodiments, the at least one instruction, when executed by the processor 501, enables the processor 501 to perform the following steps:

filling a texture of an oral portion of the face-morphed reference image into an oral portion of the face-morphed target image in response to the mouth state being an open state, and updating a setting parameter of a histogram of a skin region in the face-morphed target image according to a histogram of a skin region in the face-morphed reference image.

In some embodiments, the at least one instruction, when executed by the processor 501, enables the processor 501 to perform the following step:

updating a setting parameter of a histogram of a skin region in the face-morphed target image according to a histogram of a skin region in the face-morphed reference image in response to the mouth state being a closed state.

In some embodiments, the at least one instruction, when executed by the processor 501, enables the processor 501 to perform the following step:

updating a setting parameter of a histogram of a skin region in the face-morphed target image according to a histogram of a skin region in the face-morphed reference image in response to a situation that the mouth state of the face-morphed reference image is the same as the mouth state of the face-morphed target image.

Optionally, the electronic device is a server corresponding to a client or a terminal device installed with the client. When the electronic device is the terminal device, the terminal device is one of a smart phone, a computer, a digital broadcasting terminal, a messaging device, a game device, a tablet device, an entertainment device, a medical device, a fitness device, or a personal digital assistant.

In an example embodiment, a computer program product is provided. The computer program product, when running on a processor of an electronic device, enables the electronic device to perform the following steps:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

In some embodiments, the computer program product, when running on the processor of the electronic device, enables the electronic device to perform the following steps:

determining first morphing coordinates based on the first facial posture information and the second facial posture information, wherein the first morphing coordinates are coordinates to which the second facial key point is to be moved in the case that the designated image is morphed into the reference image; and

acquiring the reference image by moving the second facial key point to a position indicated by the first morphing coordinates.

In some embodiments, the computer program product, when running on the processor of the electronic device, enables the electronic device to perform the following steps:

determining second morphing coordinates which are weighted average coordinates of coordinates of the third facial key point and coordinates of the first facial key point; and

acquiring the face-morphed reference image and the face-morphed target image by moving the third facial key point and the first facial key point to positions indicated by the second morphing coordinates in images corresponding to the third facial key point and the first facial key point respectively.

In some embodiments, the computer program product, when running on the processor of the electronic device, enables the electronic device to perform the following steps:

determining target morphing coordinates, wherein the target morphing coordinates are coordinates to which a mouth key point in the first facial key point is to be moved, and are configured to adjust a mouth open ratio of the target image to be the same as that of the reference image; and

moving the mouth key point to a position indicated by the target morphing coordinates.

In some embodiments, the computer program product, when running on the processor of the electronic device, enables the electronic device to perform the following steps:

determining an update mode of the facial texture of the face-morphed target image based on a mouth state of the face-morphed reference image in response to a situation that the mouth state of the face-morphed reference image is different from a mouth state of the face-morphed target image; and

acquiring the face-changed image by updating the facial texture of the face-morphed target image based on the facial texture of the face-morphed reference image and the update mode.

In some embodiments, the computer program product, when running on the processor of the electronic device, enables the electronic device to perform the following step:

filling a texture of an oral portion of the face-morphed reference image into an oral portion of the face-morphed target image in response to the mouth state being an open state, and updating a setting parameter of a histogram of a skin region in the face-morphed target image according to a histogram of a skin region in the face-morphed reference image.

In some embodiments, the computer program product, when running on the processor of the electronic device, enables the electronic device to perform the following step:

updating a setting parameter of a histogram of a skin region in the face-morphed target image according to a histogram of a skin region in the face-morphed reference image as a reference in response to the mouth state being a closed state.

In some embodiments, the computer program product, when running on the processor of the electronic device, enables the electronic device to perform the following step:

updating a setting parameter of a histogram of a skin region in the face-morphed target image according to a histogram of a skin region in the face-morphed reference image in response to a situation that the mouth state of the face-morphed reference image is the same as the mouth state of the face-morphed target image.

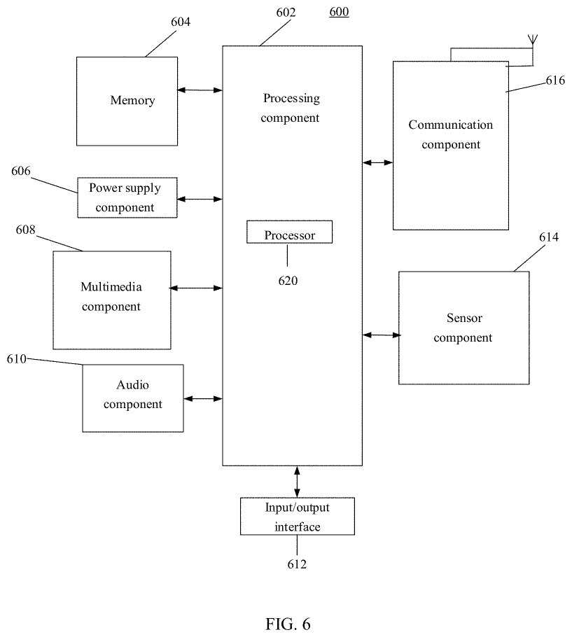

FIG. 6 is a block diagram of an apparatus 600 for changing faces for a facial image according to an embodiment of the present disclosure. Fox example, the apparatus 600 may be a mobile phone, a computer, a digital broadcasting terminal, a messaging device, a game console, a tablet device, a medical device, a fitness device, or a personal digital assistant.

Optionally, referring to FIG. 6, the apparatus 600 includes one or more following components: a processing component 602, a memory 604, a power supply component 606, a multimedia component 608, an audio component 610, an input/output (I/O) interface 612, a sensor component 614. and a communication component 616.

The processing component 602 typically controls overall operations of the apparatus 600, such as the operations associated with display, telephone calls, data communications, camera operations and recording operations. The processing component 602 includes one or more processors 620 to execute instructions to realize all or part of the steps in the above described methods. Moreover, the processing component 602 includes one or more modules which facilitate the interaction between the processing component 602 and other components. For example, the processing component 602 includes a multimedia module to facilitate the interaction between the multimedia component 608 and the processing component 602.

The memory 604 is configured to store various types of data to support the operations of the apparatus 600. Examples of such data include instructions for any applications or methods operated on the apparatus 600, contact data, phonebook data, messages, pictures, video, etc. The memory 604 is implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 606 provides power to various components of the apparatus 600. The power supply component 606 includes a power source management system, one or more power sources, and any other components associated with the generation, management, and distribution of power in the apparatus 600.

The multimedia component 608 includes a screen providing an output interface between the apparatus 600 and a user. In some embodiments, the screen includes a liquid crystal display (LCD) and a touch panel (TP). If the screen includes the touch panel, the screen is implemented as a touch screen to receive input signals from the user. The touch panel includes one or more touch sensors to sense touches, swipes, and gestures on the touch panel. The touch sensors not only sense a boundary of a touch or swipe action, but also sense a period of time and a pressure associated with a touch or swipe action. In some embodiments, the multimedia component 608 includes a front camera and/or a rear camera. The front camera and/or the rear camera can receive an external multimedia datum while the apparatus 600 is in an operation mode, such as a photographing mode or a video mode. Each of the front and rear cameras is a fixed optical lens system or has a focus and optical zoom capability.

The audio component 610 is configured to output and/or input audio signals. For example, the audio component 610 includes a microphone (MIC) configured to receive an external audio signal when the apparatus 600 is in an operation mode, such as a call mode, a recording mode, and a voice recognition mode. The received audio signal is further stored in the memory 604 or transmitted via the communication component 616. In some embodiments, the audio component 610 further includes a speaker used to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the apparatus 600. For instance, the sensor component 614 detects an open/closed status of the apparatus 600, relative positioning of components, e.g., the display and the keypad, of the apparatus 600, a change in position of the apparatus 600 or a component of the apparatus 600, a presence or absence of user's contact with the apparatus 600, an orientation or an acceleration/deceleration of the apparatus 600, and a change in temperature of the apparatus 600. The sensor component 614 includes a proximity sensor configured to detect the presence of nearby objects without any physical contact. The sensor component 614 further includes a light sensor, such as a CMOS or CCD image sensor, for use in imaging applications. In some embodiments, the sensor component 614 further includes an accelerometer sensor, a gyroscope sensor, a magnetic sensor, a pressure sensor, or a temperature sensor.

The communication component 616 is configured to facilitate wired or wireless communication between the apparatus 600 and other equipment. The apparatus 600 accesses a wireless network based on a communication standard, such as Wi-Fi, an operator network (such as 2G, 3G, 4G, or 5G), or a combination thereof. In one example embodiment, the communication component 616 receives a broadcast signal or broadcast associated information from an external broadcast management system via a broadcast channel. In one example embodiment, the communication component 616 further includes a near-field communication (NFC) module to facilitate short-range communications. For example, the NFC module may be implemented based on the radio frequency identification (RFID) technology, infrared data association (IrDA) technology, ultra-wideband (UWB) technology, Bluetooth (BT) technology, and other technologies.

In example embodiments, the apparatus 600 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing any of the methods for changing faces as described above.

An example embodiment provides a storage medium including at least one instruction therein, such as a memory 604 including at least one instruction. The at least one instruction, when executed by a processor 620 of the apparatus 600, enables the apparatus 600 to perform the following steps:

acquiring first facial posture information and a first facial key point of a target image and second facial posture information and a second facial key point of a designated image by three-dimensional face reconstruction based on the target image and the designated image, wherein the designated image is a facial image used in the face changing of the target image,

wherein the first facial posture information and the second facial posture information are three-dimensional facial posture information, and the first facial key point and the second facial key point are three-dimensional facial key points;

morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;

acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and

acquiring a face-changed image by updating a facial texture of the face-morphed target image based on a facial texture of the face-morphed reference image.

In some embodiments, the at least one instruction, when executed by the processor 620 of the apparatus 600, enables the apparatus 600 to perform the following steps:

determining first morphing coordinates based on the first facial posture information and the second facial posture information, wherein the first morphing coordinates are coordinates to which the second facial key point is to be moved in the case that the designated image is morphed into the reference image; and

acquiring the reference image by moving the second facial key point to a position indicated by the first morphing coordinates.

In some embodiments, the at least one instruction, when executed by the processor 620 of the apparatus 600, enables the apparatus 600 to perform the following steps:

determining second morphing coordinates which are weighted average coordinates of coordinates of the third facial key point and coordinates of the first facial key point; and

acquiring the face-morphed reference image and the face-morphed target image by moving the third facial key point and the first facial key point to positions indicated by the second morphing coordinates in images corresponding to the third facial key point and the first facial key point respectively.

In some embodiments, the at least one instruction, when executed by the processor 620 of the apparatus 600, enables the apparatus 600 to perform the following steps:

determining target morphing coordinates, wherein the target morphing coordinates are coordinates to which a mouth key point in the first facial key point is to be moved, and are configured to adjust a mouth open ratio of the target image to be the same as that of the reference image; and

moving the mouth key point to a position indicated by the target morphing coordinates.

In some embodiments, the at least one instruction, when executed by the processor 620 of the apparatus 600, enables the apparatus 600 to perform the following steps:

determining an update mode of the facial texture of the face-morphed target image based on a mouth state of the face-morphed reference image in response to a situation that the mouth state of the face-morphed reference image is different from a mouth state of the face-morphed target image; and

acquiring the face-changed image by updating the facial texture of the face-morphed target image based on the facial texture of the face-morphed reference image and the update mode.

In some embodiments, the at least one instruction, when executed by the processor 620 of the apparatus 600, enables the apparatus 600 to perform the following steps:

filling a texture of an oral portion of the face-morphed reference image into an oral portion of the face-morphed target image in response to the mouth state being an open state, and updating a setting parameter of a histogram of a skin region in the face-morphed target image according to a histogram of a skin region in the face-morphed reference image.

In some embodiments, the at least one instruction, when executed by the processor 620 of the apparatus 600, enables the apparatus 600 to perform the following steps:

updating a setting parameter of a histogram of a skin region in the face-morphed target image according to a histogram of a skin region in the face-morphed reference image in response to the mouth state being a closed state.

In some embodiments, the at least one instruction, when executed by the processor 620 of the apparatus 600, enables the apparatus 600 to perform the following step:

updating a setting parameter of a histogram of a skin region in the face-morphed target image according to a histogram of a skin region in the face-morphed reference image in response to a situation that the mouth state of the face-morphed reference image is the same as the mouth state of the face-morphed target image.

Optionally, the storage medium is a non-transitory computer-readable storage medium. For example, the non-transitory computer-readable storage medium is a ROM, a RAM, a CD-ROM, a magnetic tape, a floppy disc, an optical data storage device, or the like

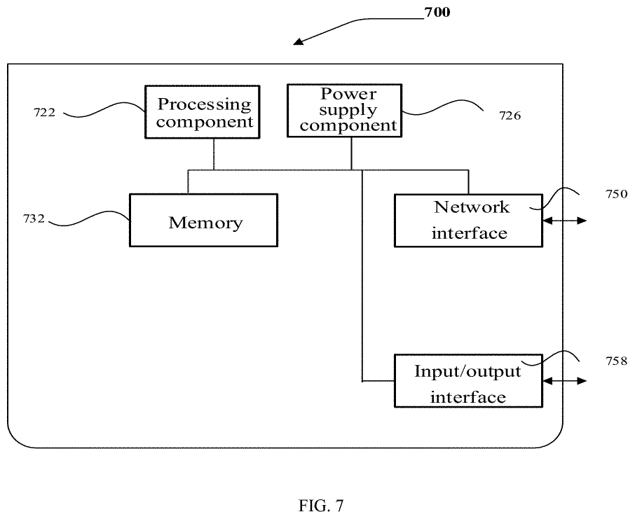

FIG. 7 is a block diagram of a device 700 for use in changing faces for a facial image according to an embodiment of the present disclosure. For example, the device 700 is provided as a server. Referring to FIG. 7, the device 700 includes a processing component 722, and further includes one or more processors, and a memory resource represented by a memory 732 for storing instructions, such as an application program, executable by the processing component 722. The application program stored in the memory 732 includes one or more modules each of which corresponds to a set of instructions. In addition, the processing component 722 is configured to execute the instructions to execute the method for changing faces for the facial image as described above.

The device 700 may further include: a power supply component 726 configured to manage power of the device 700, a wired or wireless network interface 750 configured to connect the apparatus 700 to a network, and an input/output (I/O) interface 758. The device 700 operates based on an operating system, such as Windows Server™, Mac OS X™, Unix™, Linux™, or FreeBSD™ stored in the memory 732.

Other embodiments of the present disclosure are apparent to those skilled in the art from consideration of the description and practice of the present disclosure disclosed here. The present disclosure is intended to cover any variations, uses, or adaptations of the present disclosure following the general principles thereof and including such departures from the present disclosure as come within known or customary practice in the art. It is intended that the description and examples be considered as examples only, with a true scope and spirit of the present disclosure being defined by the claims.

It is appreciated that the present disclosure is not limited to the exact construction that has been described above and illustrated in the accompanying drawings, and that various modifications and changes can be made without departing from the scope thereof. It is intended that the scope of the present disclosure is only defined by the appended claims.

What is claimed is:

1. A method for changing faces for a facial image, comprising:
acquiring first facial posture information and a first facial key point of a target image and second facial posture information and a second facial key point of a designated image by three-dimensional face reconstruction based on the target image and the designated image, wherein the designated image is a facial image used in the face changing of the target image,
wherein the first facial posture information and the second facial posture information are three-dimensional facial posture information, and the first facial key point and the second facial key point are three-dimensional facial key points;
morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;
acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and
acquiring a face-changed image by updating a facial texture of the face-morphed target image based on a facial texture of the face-morphed reference image.

2. The method according to claim 1, wherein said morphing the designated image into the reference image comprises:
determining first morphing coordinates based on the first facial posture information and the second facial posture information, wherein the first morphing coordinates are coordinates to which the second facial key point is to be moved in the case that the designated image is morphed into the reference image; and
acquiring the reference image by moving the second facial key point to a position indicated by the first morphing coordinates.

3. The method according to claim 1, wherein said acquiring the face-morphed reference image and the face-morphed target image comprises:
determining second morphing coordinates, wherein the second morphing coordinates are weighted average coordinates of coordinates of the third facial key point and coordinates of the first facial key point; and
acquiring the face-morphed reference image and the face-morphed target image by moving the third facial key point and the first facial key point to positions indicated by the second morphing coordinates in images corresponding to the third facial key point and the first facial key point respectively.

4. The method according to claim 3, further comprising:
determining target morphing coordinates, wherein the target morphing coordinates are coordinates to which a mouth key point in the first facial key point is to be moved, and are configured to adjust a mouth open ratio of the target image to be the same as that of the reference image; and
moving the mouth key point to a position indicated by the target morphing coordinates.

5. The method according to claim 1, wherein said acquiring the face-changed image by updating the facial texture of the face-morphed target image based on the facial texture of the face-morphed reference image comprises:
determining an update mode of the facial texture of the face-morphed target image based on a mouth state of the face-morphed reference image in response to a situation that the mouth state of the face-morphed reference image the face-morphed target image are different; and
acquiring the face-changed image by updating the facial texture of the face-morphed target image based on the facial texture of the face-morphed reference image and the update mode.

6. The method according to claim 5, wherein said acquiring the face-changed image by updating the facial texture of the face-morphed target image based on the facial texture of the face-morphed reference image and the update mode comprises:
filling a texture of an oral portion of the face-morphed reference image into an oral portion of the face-morphed target image in response to the mouth state being an open state;
updating a setting parameter of a histogram of a skin region in the face-morphed target image according to a histogram of a skin region in the face-morphed reference image.

7. The method according to claim 5, wherein said acquiring the face-changed image by updating the facial texture of the face-morphed target image based on the facial texture of the face-morphed reference image and the update mode comprises:
updating a setting parameter of a histogram of a skin region in the face-morphed target image according to a histogram of a skin region in the face-morphed reference image in response to the mouth state being a closed state.

8. The method according to claim 1, wherein said acquiring the face-changed image by updating the facial texture of the face-morphed target image based on the facial texture of the face-morphed reference image comprises:
updating a setting parameter of a histogram of a skin region in the face-morphed target image according to a histogram of a skin region in the face-morphed reference image in response to a situation that the mouth state of the face-morphed reference image and the mouth state of the face-morphed target image are the same.

9. An electronic device, comprising:
a processor; and
a memory configured to store at least one instruction executable by the processor,
wherein the at least one instruction, when executed by the processor, causes the processor to perform a method comprising:
acquiring first facial posture information and a first facial key point of a target image and second facial posture information and a second facial key point of a designated image by three-dimensional face reconstruction based on the target image and the designated image, wherein the designated image is a facial image used in the face changing of the target image,
wherein the first facial posture information and the second facial posture information are three-dimensional facial posture information, and the first facial key point and the second facial key point are three-dimensional facial key points;
morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;
acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and
acquiring a face-changed image by updating a facial texture of the face-morphed target image based on a facial texture of the face-morphed reference image.

10. The electronic device according to claim 9, wherein said morphing the designated image into the reference image comprises:
determining first morphing coordinates based on the first facial posture information and the second facial posture information, wherein the first morphing coordinates are coordinates to which the second facial key point is to be moved in the case that the designated image is morphed into the reference image; and
acquiring the reference image by moving the second facial key point to a position indicated by the first morphing coordinates.

11. The electronic device according to claim 9, wherein said acquiring the face-morphed reference image and the face-morphed target image comprises:
determining second morphing coordinates which are weighted average coordinates of coordinates of the third facial key point and coordinates of the first facial key point; and
acquiring the face-morphed reference image and the face-morphed target image by moving the third facial key point and the first facial key point to positions indicated by the second morphing coordinates in images corresponding to the third facial key point and the first facial key point respectively.

12. The electronic device according to claim 11, wherein the method further comprises:
determining target morphing coordinates, wherein the target morphing coordinates are coordinates to which a mouth key point in the first facial key point is to be moved, and are configured to adjust a mouth open ratio of the target image to be the same as that of the reference image; and
moving the mouth key point to a position indicated by the target morphing coordinates.

13. The electronic device according to claim 9, wherein said acquiring the face-changed image by updating the facial texture of the face-morphed target image based on the facial texture of the face-morphed reference image comprises:
determining an update mode of the facial texture of the face-morphed target image based on a mouth state of the face-morphed reference image in response to a situation that the mouth state of the face-morphed reference image and a mouth state of the face-morphed target image are different; and
acquiring the face-changed image by updating the facial texture of the face-morphed target image based on the facial texture of the face-morphed reference image and the update mode.

14. The electronic device according to claim 13, wherein said acquiring the face-changed image by updating the facial texture of the face-morphed target image based on the facial texture of the face-morphed reference image and the update mode comprises:
filling a texture of an oral portion of the face-morphed reference image into an oral portion of the face-morphed target image in response to the mouth state being an open state, and
updating a setting parameter of a histogram of a skin region in the face-morphed target image according to a histogram of a skin region in the face-morphed reference image.

15. The electronic device according to claim 13, wherein said acquiring the face-changed image by updating the facial texture of the face-morphed target image based on the facial texture of the face-morphed reference image and the update mode comprises:
updating a setting parameter of a histogram of a skin region in the face-morphed target image according to a histogram of a skin region in the face-morphed reference image in response to the mouth state being a closed state.

16. The electronic device according to claim 9, wherein said acquiring the face-changed image by updating the facial texture of the face-morphed target image based on the facial texture of the face-morphed reference image comprises:
updating a setting parameter of a histogram of a skin region in the face-morphed target image according to a histogram of a skin region in the face-morphed reference image in response to a situation that the mouth state of the face-morphed reference image and the mouth state of the face-morphed target image are the same.

17. A non-transitory storage medium storing at least one instruction therein, wherein the at least one instruction, when executed by a processor or an electronic device, causes the processor to perform a method comprising:
acquiring first facial posture information and a first facial key point of a target image and second facial posture information and a second facial key point of a designated image by three-dimensional face reconstruction based on the target image and the designated image, wherein the designated image is a facial image used in the face changing of the target image,
wherein the first facial posture information and the second facial posture information are three-dimensional facial posture information, and the first facial key point and the second facial key point are three-dimensional facial key points;
morphing the designated image into a reference image by using the second facial key point as a morphing control point based on the first facial posture information and the second facial posture information, wherein facial posture information of the reference image is the same as the first facial posture information, and a third facial key point of the reference image is a three-dimensional facial key point formed after the designated image is morphed;
acquiring a face-morphed reference image and a face-morphed target image by face-morphing the target image and the reference image by using the first facial key point and the third facial key point as morphing control points respectively, wherein a facial similarity between the face-morphed reference image and the face-morphed target image meets a target condition; and
acquiring a face-changed image by updating a facial texture of the face-morphed target image based on a facial texture of the face-morphed reference.

18. The storage medium of claim 17, wherein said morphing the designated image into the reference image comprises:
determining first morphing coordinates according to the first facial posture information and the second facial posture information, wherein the first morphing coordinates are coordinates to which the second facial key point is to be moved in the case that the designated image is morphed into the reference image; and
acquiring the reference image by the second facial key point to a position indicated by the first morphing coordinates.

19. The storage medium of claim 17, wherein said acquiring the face-morphed reference image and the face-morphed target image comprises:
determining second morphing coordinates which are weighted average coordinates of coordinates of the third facial key point and coordinates of the first facial key point; and
acquiring the face-morphed reference image and the face-morphed target image by moving the third facial key point and the first facial key point to positions indicated by the second morphing coordinates in images corresponding to the third facial key point and the first facial key point respectively.

20. The storage medium of claim 19, wherein the method further comprises:
determining target morphing coordinates, wherein the target morphing coordinates are coordinates to which a mouth key point in the first facial key point is to be moved, and are configured to adjust a mouth open ratio of the target image to be the same as that of the reference image; and
moving the mouth key point to a position indicated by the target morphing coordinates.
